(19) United States
(12) Patent Application Publication
(10) Pub. No.: US 2026/0164113 A1
(43) Pub. Date: Jun. 11, 2026

(54) ELECTRONIC DEVICE FOR CAPTURING VIRTUAL SPACE AND OPERATION METHOD THEREOF

(71) Applicant: SAMSUNG ELECTRONICS CO., LTD., Suwon-si (KR)

(72) Inventors: Bonseuk GOO, Suwon-si (KR); Youngtae KIM, Suwon-si (KR); Byungseok SOH, Suwon-si (KR); Youngchol LEE, Suwon-si (KR); Weonhee LEE, Suwon-si (KR); Kisung LEE, Suwon-si (KR); Yongseok JANG, Suwon-si (KR)

(73) Assignee: SAMSUNG ELECTRONICS CO., LTD., Suwon-si (KR)

(21) Appl. No.: 19/183,433

(22) Filed: Apr. 18, 2025

Related U.S. Application Data
(63) Continuation of application No. PCT/KR2023/012088, filed on Aug. 16, 2023.

(30) Foreign Application Priority Data
Oct. 18, 2022 (KR) 10-2022-0134467
Jan. 26, 2023 (KR) 10-2023-0010227

(51) Int. Cl. H04N 23/611; G06F 3/04817; G06T 17/00; G06V 40/20

(52) U.S. Cl. CPC H04N 23/611; G06F 3/04817; G06T 17/00; G06V 40/28

(57) ABSTRACT

An electronic device and an operation method of the electronic device are provided. The electronic device includes a display, memory storing one or more instructions, and at least one processor. The at least one processor is configured to execute the one or more instructions to control the display to display a virtual space, based on a first gesture for capturing the virtual space, determine an object to be captured within the virtual space, based on a second gesture for selecting a capture mode, determine the capture mode, and generate a captured image of the object based on capturing the virtual space according to the capture mode.

### CROSS-REFERENCES TO RELATED APPLICATIONS

This application is a continuation of International App. No. PCT/KR 2023/012088, filed on Aug. 16, 2023, with the Korean Intellectual Property Office, which claims priority from Korean Application No. 10-2022-0134467, filed on Oct. 18, 2022, and Korean Application No. 10-2023-0010227, filed on Jan. 26, 2023, filed with the Korean Intellectual Property Office, the disclosures of which are incorporated by reference herein in their entireties.

### BACKGROUND

### 1. Field

Various embodiments relate to an electronic device and an operation method of the electronic device, and more particularly, to an electronic device for capturing a virtual space and an operation method of the electronic device.

### 2. Related Art

Recently, interest has grown in the next-generation media environment that allows users to experience content in a virtual space similar to a real space. In particular, metaverse has drawn attention as a representative service that provides a virtual space to users. Metaverse is a compound word of meta, meaning fiction or abstraction, and universe, meaning a real world, and refers to a three-dimensional (3D) virtual world. The core technology of the metaverse is extended reality (XR) technology, which encompasses virtual reality (VR), augmented reality (AR), and mixed reality (MR). There are various methods to implement a virtual space, but the methods all have in common the feature of using virtual 3D images to interact in real time with users in a real space.

An electronic device may be used to display a virtual space screen to allow users to experience virtual space content. In particular, users may want to share or record their experiences in virtual spaces with others by using electronic devices. In this case, when an image that a user sees in a virtual space is captured as a simple two-dimensional (2D) image, there are limitations in expressing various viewpoints and emotions experienced by the user.

### SUMMARY

An electronic device according to an embodiment of the present disclosure includes a display, memory storing one or more instructions, and at least one processor. The at least one processor is configured to execute the one or more instructions to control the display to display a virtual space. The at least one processor is configured to, based on a first gesture for capturing the virtual space, determine an object to be captured within the virtual space, based on a second gesture for selecting a capture mode, determine the capture mode, and generate a captured image of the object based on capturing the virtual space according to the capture mode.

An operation method of an electronic device according to an embodiment of the present disclosure includes controlling a display of the electronic device to display a virtual space; based on a first gesture for capturing the virtual space, determining an object to be captured within the virtual space; based on a second gesture for selecting a capture mode, determining the capture mode; and generating a captured image of the object based on capturing the virtual space according to the capture mode.

### BRIEF DESCRIPTION OF DRAWINGS

FIG. 1 is a diagram for illustrating a capture service of an electronic device according to an embodiment.

FIG. 2 is a block diagram illustrating a configuration of an electronic device according to an embodiment.

FIG. 3 is a flowchart of an example process of an electronic device according to an embodiment.

FIG. 4 is a flowchart of an example process of an electronic device providing a capture service according to an embodiment.

FIG. 5 is a diagram illustrating an operation of an electronic device, for initiating a capture service, according to an embodiment.

FIG. 6 is a diagram illustrating an operation of an electronic device, for determining a capture mode, according to an embodiment.

FIG. 7 is a diagram illustrating a type of a multi-view capture mode from among capture modes according to an embodiment.

FIG. 8 is a diagram illustrating an operation of an electronic device, for determining a capture area, according to an embodiment.

FIG. 9 is a diagram illustrating an operation of an electronic device, for determining a capture area, according to an embodiment.

FIG. 10 is a diagram illustrating a method of detecting a first gesture through a sensor of an electronic device according to an embodiment.

FIG. 11 is a diagram illustrating a method of detecting a second gesture through a sensor of an electronic device according to an embodiment.

FIG. 12 is a diagram illustrating a method of detecting a third gesture through a sensor of an electronic device according to an embodiment.

FIG. 13 is a block diagram showing the configuration of an electronic device according to an embodiment.

FIG. 14 is a block diagram showing the configuration of a server according to an embodiment.

### DETAILED DESCRIPTION

In the present disclosure, the expression “at least one of a, b or c” may refer to “a”, “b”, “c”, “a and b”, “a and c”, “b and c”, “all of a, b and c”, or variations thereof.

Hereinafter, embodiments of the present disclosure are described in detail such that those of skill in the art may easily implement the same with reference to the accompanying drawings. However, the present disclosure may be implemented in various different forms and is not limited to the embodiments described herein.

Although the functions mentioned in the present disclosure are described in terms of current general terms, this may mean various other terms depending on the intention of those of skill in the art, precedents, emergence of new technologies, and the like. Therefore, the terms used in the present disclosure should not be interpreted solely based on the names of the terms, but should be interpreted based on the meanings of the terms and the overall contents of the present disclosure.

The term used in the present disclosure is for the purpose of describing particular embodiments only and is not intended to limit the present disclosure.

Throughout this specification, unless explicitly described to the contrary, the word “comprise (include)” and variations such as “comprises (includes)” or “comprising (including)”, will be understood to imply the inclusion of stated elements but not the exclusion of any other elements. The terms such as “...unit” or “module” disclosed in the specification mean units for processing at least one function or operation, which may be implemented by hardware, software, or a combination thereof.

Hereinafter, embodiments are described in detail such that those of skill in the art may easily implement the same with reference to the accompanying drawings. However, the present disclosure may be implemented in various different forms and is not limited to the embodiments described herein. To clearly explain the present disclosure in the drawings, portions that are not related to explanation are omitted, and similar portions are given similar drawing reference numerals throughout the specification.

The term “user” in the embodiments of this specification means a person who controls a system, function or operation, and may include a developer, an administrator or an installer.

The present disclosure will be described in detail with reference to the attached drawings below.

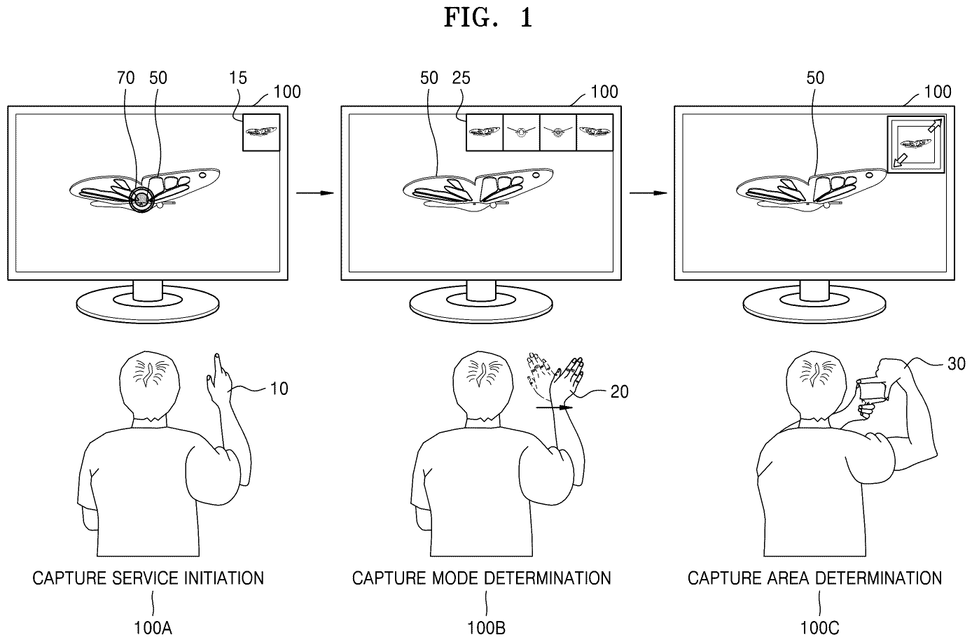

FIG. 1 is a diagram for explaining a capture service of an electronic device according to an embodiment.

Referring to FIG. 1, an electronic device 100 according to an embodiment of the present disclosure may be an electronic device capable of outputting an image. According to an example, the electronic device 100 may be implemented as various forms of electronic devices including a display. The electronic device 100 may be stationary or mobile and may be a digital television (TV) for receiving digital broadcasting, but is not limited thereto.

The electronic device 100 according to an embodiment of the present disclosure may provide a virtual space. The virtual space is a space that represents a virtual reality that is different from actual reality, and users may experience various virtual spaces through avatars that reflects the users. The virtual space may be implemented as a three-dimensional (3D) space image. For example, the electronic device 100 may provide content including an image, a video, a text, and an application that are implemented as a 3D space image.

The electronic device 100 according to an embodiment of the present disclosure may include at least one of a desktop, a smartphone, a tablet personal computer (PC), a mobile phone, a video phone, an e-book reader, a laptop PC, a netbook computer, a digital camera, personal digital assistants (PDA), a portable multimedia player (PMP), a camcorder, a navigation device, a wearable device, a smart watch, a home network system, a security system, a medical device, a head mounted display (HMD), a hemispherical display, a large display, and a projector display.

The electronic device 100 according to an embodiment of the present disclosure may provide a capture service. The capture service according to an embodiment of the present disclosure may be a service that captures an image of a virtual space viewed by a user or stores a captured image. A user of the electronic device 100 may capture an image of the virtual space to record an experience in the virtual space. In this case, when the virtual space is captured as a two-dimensional (2D) image from a first-person viewpoint from which the user views an object, it is difficult to accurately record sense of space and experience that the user felt in the virtual space.

The electronic device 100 according to an embodiment of the present disclosure may capture an image of a virtual space viewed by a user as a 3D image, a multi-view image, or the like as well as a 2D image or a single-view image through a capture service. Accordingly, the electronic device 100 may generate a captured image containing various viewpoints and emotions experienced by the user in a virtual space.

A capture service according to an embodiment of the present disclosure may be executed through various interactions corresponding to a spatial gesture and touch of a user, and other user commands. The electronic device 100 may provide the capture service through the spatial gestures or touch of the user, or the like. The electronic device 100 may capture a virtual space by detecting the spatial gesture or touch of the user, or the like even without a separate manipulating device. For example, the spatial gesture may include a pointing gesture, a swiping gesture, a zoom-in gesture, a zoom-out gesture, a drag gesture, a pinch-in gesture, and a pinch-out gesture, which point to the same point for a certain period of time. In the present disclosure, the spatial gesture of the user is exemplified as a hand gesture, but is not limited thereto.

The capture service according to an embodiment of the present disclosure may include operation 100A of capture service initiation, operation 100B of capture mode determination, and operation 100C of capture area determination. The electronic device 100 according to an embodiment of the present disclosure may generate a captured image by performing operation 100A of capture service initiation, operation 100B of capture mode determination, and operation 100C of capture area determination. However, without being limited thereto, the electronic device 100 may generate a captured image by performing only operation 100A of capture service initiation and operation 100B of capture mode determination or may also generate the captured image by performing only operation 100B of capture mode determination and operation 100C of capture area determination. In embodiments, the electronic device 100 may generate a captured image by performing one or more of operation 100A of capture service initiation, operation 100B of capture mode determination, and operation 100C of capture area determination.

First, in operation 100A of capture service initiation, the electronic device 100 according to an embodiment of the present disclosure may initiate the capture service, based on a first gesture 10 of a user. For example, the electronic device 100 may detect the first gesture 10 of pointing to an object 50 contained within a virtual space. For example, once it is determined that the first gesture 10 is present, the electronic device 100 may initiate the capture service. For example, the electronic device 100 may determine the object 50 to be captured based on a pointing position of the first gesture 10. For example, the electronic device 100 may display, on the object 50, a highlight icon 70 indicating that the object 50 to be captured is determined.

The electronic device 100 according to an embodiment of the present disclosure may generate a captured image 15, based on the first gesture 10. The captured image 15 may be a captured image according to a preset capture mode and a preset capture area. For example, the preset capture mode may be a single-view capture mode for a current viewpoint of a user, and the preset capture area may be a range of a virtual space preset around the object 50, but the preset capture mode and the preset capture area are not limited thereto. The electronic device 100 according to an embodiment of the present disclosure may generate the captured image 15 when a pointing gesture according to the first gesture 10 is released. However, the electronic device 100 is not limited thereto. For example, the electronic device 100 may generate the captured image 15 when the pointing gesture according to the first gesture 10 is maintained for a certain period of time. The captured image 15 may be displayed in a partial area of the electronic device 100. For example, the captured image 15 may be displayed in an upper right area of the electronic device 100.

Then, in operation 100B of capture mode determination, the electronic device 100, according to an embodiment of the present disclosure, may determine a capture mode, based on a second gesture 20 of a user. For example, the electronic device 100 may detect the second gesture 20 of swiping in one direction in space. The one direction may be any one of upward, downward, left, and right directions. Upon determining that the second gesture 20 for selecting the capture mode is present, the electronic device 100, according to an embodiment of the present disclosure, may change the capture mode. For example, the electronic device 100 may change from a preset capture mode to another capture mode according to the second gesture 20. For example, the capture mode may include a multi-view capture mode and a 3D capture mode. For example, the multi-view capture mode may be a capture mode in which a captured image for multiple viewpoints obtained by rotation based on the object 50 is generated. For example, the 3D capture mode may be a capture mode in which a 3D captured image of the object 50 is generated.

The electronic device 100 according to an embodiment of the present disclosure may generate a captured image 25, based on the second gesture 20. For example, a user may select the multi-view capture mode through the second gesture 20, and the electronic device 100 may determine the capture mode as the multi-view capture mode by detecting the second gesture 20. For example, the electronic device 100 may generate the captured image 25 for multiple viewpoints obtained by rotation based on the object 50 according to the multi-view capture mode. For example, the captured image 25 may be a captured image for four viewpoints obtained by rotating 90 degrees each based on the object 50.

Upon determining that the second gesture 20 for selecting the capture mode is not present, the electronic device 100 according to an embodiment of the present disclosure may determine the capture mode as a preset capture mode without changing the capture mode. For example, the electronic device 100 may determine the capture mode as a preset capture mode when the second gesture 20 is not detected for a certain period of time after the first gesture 10 is detected. For example, the electronic device 100 may generate a captured image according to a preset capture mode.

Then, in operation 100C of capture area determination, the electronic device 100, according to an embodiment of the present disclosure may determine a capture area, based on a third gesture 30 of a user. For example, the electronic device 100 may detect the third gesture 30 of zooming in or out in space. When it is determined that the third gesture 30 for setting the capture area is present, the electronic device 100, according to an embodiment of the present disclosure, may change the capture area. For example, the electronic device 100 may extend or reduce a preset capture area according to the third gesture 30. For example, when the capture area is extended, a range of a virtual space to be captured may be extended. For example, when the capture area is reduced, a range of a virtual space to be captured may be reduced.

The electronic device 100, according to an embodiment of the present disclosure, may generate a captured image with an extended or reduced capture area, based on the third gesture 30. For example, the electronic device 100 may extend the capture area by detecting a zoom-in gesture and generate an extended captured image 35.

When it is determined that the third gesture 30 for setting a capture area is not present, the electronic device 100 according to an embodiment of the present disclosure may determine the capture area as a preset capture area without changing the capture area. For example, the electronic device 100 may generate a captured image according to the preset capture area.

The electronic device 100 according to an embodiment of the present disclosure may generate a captured image containing various viewpoints and emotions experienced by a user in a virtual space through a capture service.

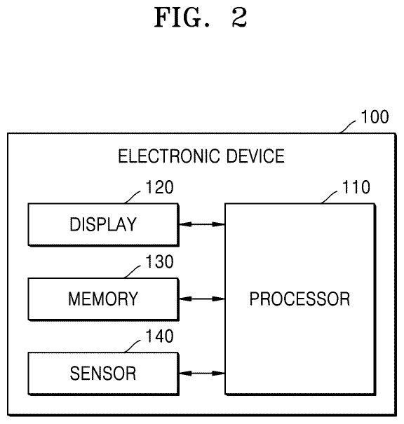

FIG. 2 is a block diagram showing a configuration of an electronic device according to an embodiment.

Referring to FIG. 2, the electronic device 100 according to an embodiment may include a processor 110, a display 120, memory 130, and a sensor 140.

The display 120 according to an embodiment may display a virtual space under control of the processor 110. The display 120 according to an embodiment may provide a captured image containing various viewpoints and emotions experienced by a user in a virtual space under control of the processor 110.

The memory 130 according to an embodiment may store various data, programs or applications for driving and controlling the electronic device 100. The program stored in the memory 130 according to an embodiment may include one or more instructions. The program (one or more instructions) or application stored in the memory 130 may be executed by the processor 110.

The memory 130 according to an embodiment may include at least one type of storage medium from among a flash memory type, a hard disk type, a multimedia card micro type, card type memory (e.g., SD or XD memory), random access memory (RAM), static random access memory (SRAM), read-only memory (ROM), electrically erasable programmable read-only memory (EEPROM), programmable read-only memory (PROM), magnetic memory, a magnetic disk, and an optical disk.

The sensor 140 according to an embodiment may detect the presence, position, and type of user gestures including a spatial gesture or touch of the user. For example, the sensor 140 may include at least one sensor. For example, the sensor 140 may include a distance sensor and an image sensor.

The processor 110 according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing variety of the recited/disclosed functions, e.g., in a distributed manner. At least one processor may execute program instructions to achieve or perform various functions.

The processor 110 according to an embodiment may be configured to control the overall operation of the electronic device 100, control signal flow between internal components of the electronic device 100, and perform a function of processing data.

The processor 110 according to an embodiment may include at least one of a central processing unit (CPU), a graphic processing unit (GPU), and a video processing unit (VPU). Alternatively, the processor 110 according to an embodiment may be implemented in the form of a system on chip (SoC) obtained by integrating at least one of a CPU, a GPU, and a VPU. Alternatively, the processor 110 may further include a neural processing unit (NPU).

The processor 110 according to an embodiment may be configured to execute one or more instructions stored in the memory 130 to control operations of the electronic device 100 to be performed.

The processor 110 according to an embodiment of the present disclosure may control the display 120 to display a virtual space. The processor 110 according to an embodiment of the present disclosure may determine an object to be captured within the virtual space, based on a first gesture for capturing the virtual space. The processor 110 according to an embodiment of the present disclosure may determine a capture mode, based on a second gesture for selecting a capture mode. The processor 110 according to an embodiment of the present disclosure may generate a captured image obtained by capturing a virtual space according to the determined capture mode.

The processor 110 according to an embodiment of the present disclosure may determine whether a first gesture of pointing to an object is present through at least one sensor 140.

The processor 110 according to an embodiment of the present disclosure may determine the position of a user hand through a first sensor. The processor 110 according to an embodiment of the present disclosure may determine a pointing direction pointed by the user hand through a second sensor. The processor 110 according to an embodiment of the present disclosure may determine the position of an object in a virtual space, pointed by the user hand, based on the position and the pointing direction of the user hand.

The processor 110 according to an embodiment of the present disclosure may control the display 120 to display a highlight icon indicating that an object to be captured is determined, based on a first gesture.

The capture mode according to an embodiment of the present disclosure may include any one of a single-view capture mode in which a captured image for a current viewpoint is generated, a multi-view capture mode in which a captured image for multiple viewpoints obtained by rotation based on an object is generated, and a 3D capture mode in which a 3D captured image for the object is generated.

The processor 110 according to an embodiment of the present disclosure may generate a captured image according to the determined capture mode, based on determining that a second gesture is present. The processor 110 according to an embodiment of the present disclosure may generate a captured image according to a preset capture mode, based on determining that the second gesture is not present.

The processor 110 according to an embodiment of the present disclosure may determine whether the second gesture is present, based on movement of the user hand, detected through the at least one sensor 140.

The processor 110 according to an embodiment of the present disclosure may generate a captured image according to a next capture mode, based on a user hand moving in a first direction. The processor 110 according to an embodiment of the present disclosure may generate a captured image according to a previous capture mode, based on a user hand moving in a second direction opposite to the first direction.

The processor 110 according to an embodiment of the present disclosure may determine a range of a virtual space to be captured, based on a third gesture for setting a capture area.

The processor 110 according to an embodiment of the present disclosure may generate a captured image in which a range of a virtual space to be captured is extended or reduced, based on determining that the third gesture is present. The processor 110 according to an embodiment of the present disclosure may generate a captured image according to a preset capture area, based on determining that the third gesture is not present.

The processor 110 according to an embodiment of the present disclosure may determine whether the third gesture is present, based on user hands zooming in or out detected through the at least one sensor 140.

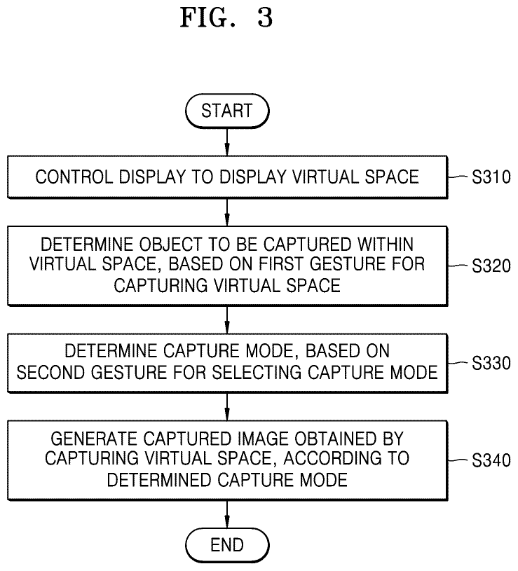

FIG. 3 is a flowchart showing an example of an operation method of an electronic device according to an embodiment.

Referring to FIG. 3, in operation S310, the operation method of the electronic device 100 according to an embodiment of the present disclosure may include controlling a display to display a virtual space.

In operation S320, the operation method of the electronic device 100 according to an embodiment of the present disclosure may include determining an object to be captured within the virtual space, based on a first gesture for capturing the virtual space.

In operation S330, the operation method of the electronic device 100 according to an embodiment of the present disclosure may include determining a capture mode, based on a second gesture for selecting the capture mode. The operation method of the electronic device 100 according to an embodiment of the present disclosure may include determining whether the first gesture of pointing to an object is present through the at least one sensor 140.

The operation method of the electronic device 100 according to an embodiment of the present disclosure may include generating a captured image according to the determined capture mode, based on determining that the second gesture is present. The operation method of the electronic device 100 according to an embodiment of the present disclosure may include generating a captured image according to a preset capture mode, based on determining that the second gesture is not present.

The operation method of the electronic device 100 according to an embodiment of the present disclosure may include generating a captured image according to a next capture mode, based on a user hand moving in a first direction, and generating a captured image according to a previous capture mode, based on a user hand moving in a second direction opposite to the first direction.

The operation method of the electronic device 100 according to an embodiment of the present disclosure may include determining whether the second gesture is present, based on movement of the user hand, detected through the at least one sensor 140.

In operation S340, the operation method of the electronic device 100 according to an embodiment of the present disclosure may include generating a captured image obtained by capturing a virtual space according to the determined capture mode.

The capture mode according to an embodiment of the present disclosure may include at least one of a single-view capture mode in which a captured image for a current viewpoint is generated, a multi-view capture mode in which a captured image for multiple viewpoints obtained by rotation based on an object is generated, and a 3D capture mode in which a 3D captured image for the object is generated.

The operation method of the electronic device 100 according to an embodiment of the present disclosure may include determining a range of a virtual space to be captured, based on a third gesture for setting a capture area. The operation method of the electronic device 100 according to an embodiment of the present disclosure may include generating a captured image in which a range of a virtual space to be captured is expanded or reduced, based on determining that the third gesture is present. The operation method of the electronic device 100 according to an embodiment of the present disclosure may include generating a captured image according to a preset capture area, based on determining that the third gesture is not present.

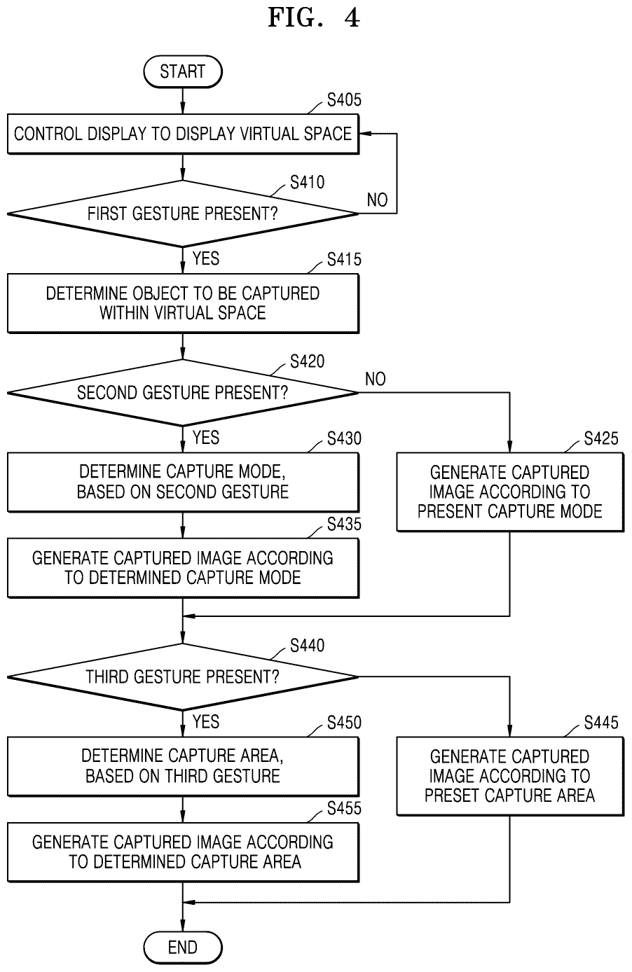

FIG. 4 is a flowchart illustrating an operation method of an electronic device providing a capture service according to an embodiment.

Referring to FIG. 4, in operation S405, the electronic device 100 according to an embodiment of the present disclosure may control a display to display a virtual space.

In operation S410, the electronic device 100 according to an embodiment of the present disclosure may determine whether a first gesture is present. For example, the electronic device 100 may identify a first gesture through a sensor. For example, the first gesture may be a gesture of pointing to an object in space. The electronic device 100 according to an embodiment of the present disclosure may perform operation S415 based on determining that the first gesture is present. For example, the electronic device 100 may perform operation S405 again based on determining that the first gesture is not present.

In operation S415, the electronic device 100 according to an embodiment of the present disclosure may determine an object to be captured within the virtual space based on determining that the first gesture is present. For example, the electronic device 100 may initiate a capture service. For example, the electronic device 100 may determine an object to be captured based on a pointing position of the first gesture. For example, the electronic device 100 may provide a highlight icon indicating that a capture service is initiated based on the first gesture. For example, the electronic device 100 may generate a captured image of the determined object, based on the first gesture. The captured image may be a captured image according to a preset capture mode and a preset capture area. For example, the preset capture mode may be, but is not limited to, a single-view capture mode. The preset capture mode may include any one of a multi-view capture mode and a 3D capture mode. For example, a preset capture area may be a defined range of a virtual space around an object.

In operation S420, the electronic device 100 according to an embodiment of the present disclosure may determine whether a second gesture is present. For example, the electronic device 100 may identify the second gesture through a sensor. For example, the second gesture may be a gesture of moving the hand in one direction in space. For example, the electronic device 100 may perform operations S430 and S435 based on determining that the second gesture is present. For example, the electronic device 100 may perform operation S425 based on determining that the second gesture is not present.

In operation S425, the electronic device 100 according to an embodiment of the present disclosure may determine a capture mode as a preset capture mode, based on determining that the second gesture is not present. The electronic device 100 according to an embodiment of the present disclosure may generate a captured image according to a preset capture mode.

In operation S430, the electronic device 100 according to an embodiment of the present disclosure may determine a capture mode, based on determining that the second gesture is present. The electronic device 100 may determine the capture mode as a changed capture mode based on the second gesture of selecting the capture mode. For example, the electronic device 100 may change the capture mode from a preset capture mode to a capture mode selected by a user, based on the second gesture. The user may change the capture mode to another capture mode to select the other capture mode or select a preset capture mode again.

In operation S435, the electronic device 100 according to an embodiment of the present disclosure may generate a captured image according to the determined capture mode. For example, the electronic device 100 may generate a captured image according to a single-view capture mode, a multi-view capture mode, a 3D capture mode, and the like.

In operation S440, the electronic device 100 according to an embodiment of the present disclosure may determine whether a third gesture is present. For example, the electronic device 100 may identify the third gesture through a sensor. For example, the third gesture may be a zoom-in or zoom-out gesture in space. For example, the electronic device 100 may perform operations S450 and S455 based on determining that the third gesture is present. For example, the electronic device 100 may perform operation S445, based on determining that the third gesture is not present.

In operation S445, the electronic device 100 according to an embodiment of the present disclosure may determine a capture area as a preset capture area based on determining that the third gesture is not present. The electronic device 100 according to an embodiment of the present disclosure may generate a captured image according to the preset capture area.

In operation S450, the electronic device 100 according to an embodiment of the present disclosure may determine a capture area based on determining that the third gesture is present. The electronic device 100 may determine the capture area based on the third gesture of setting the capture area. For example, the electronic device 100 may change the capture area from a preset capture area to the set capture area based on the third gesture. A user may extend or reduce the capture area or maintain the preset capture area.

In operation S455, the electronic device 100 according to an embodiment of the present disclosure may generate a captured image according to the determined capture area. For example, the electronic device 100 may generate a captured image with an extended or reduced capture area based on the third gesture.

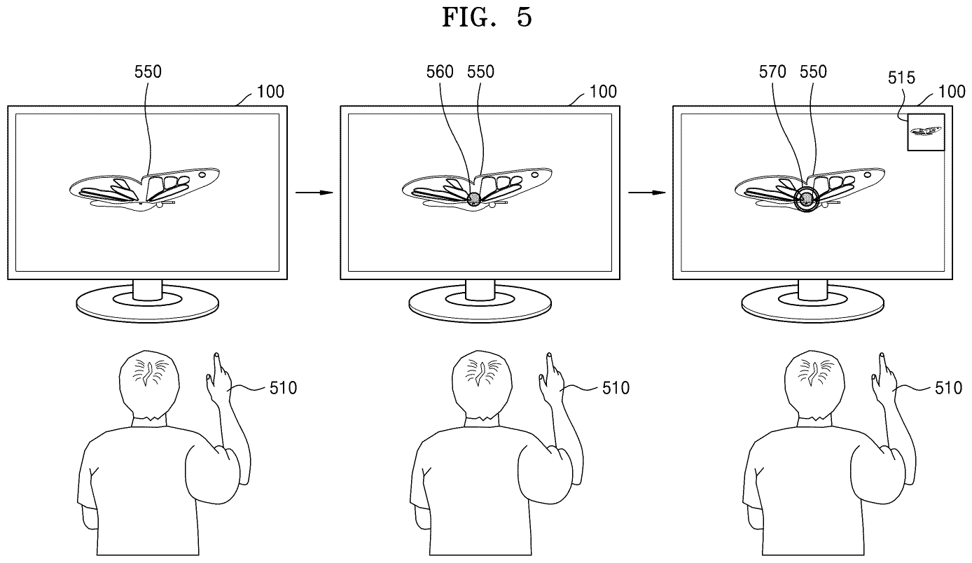

FIG. 5 is a diagram illustrating an operation of an electronic device, for initiating a capture service, according to an embodiment.

Referring to FIG. 5, the electronic device 100 according to an embodiment of the present disclosure may initiate a capture service based on a first gesture 510 of a user. For example, the electronic device 100 may detect the first gesture 510 of pointing to an object 550 contained within a virtual space. For example, the user may remain stationary for a certain period of time and point to the same spot. For example, when detecting a pointing gesture of the user that remains stationary for a certain period of time, the electronic device 100 may initiate a capture service.

The electronic device 100 according to an embodiment of the present disclosure may provide a user interface that notifies that the capture service is currently initiated. For example, the electronic device 100 may display a highlight icon 560 indicating that the capture service is currently initiated. For example, as the capture service is initiated, it may take a certain period of time to perform an operation of determining the object 550 present at the pointing position of the first gesture 510 and generating the captured image. The electronic device 100 may determine the object 550 and display the highlight icon 560 while performing operations to generate the captured image. For example, the highlight icon 560 may be, but is not limited to, a circular icon present on the object 550. For example, the highlight icon 560 may be present in various states to inform the user that “the capture service is currently initiated.”

The electronic device 100 according to an embodiment of the present disclosure may determine the object 550 present at a pointing position. The electronic device 100 according to an embodiment of the present disclosure may provide a user interface that notifies that the object 550 is determined. For example, the electronic device 100 may display a highlight icon 570 indicating that the object 550 is determined. For example, the highlight icon 570 may be, but is not limited to, a double circular icon present on the object 550. For example, the highlight icon 570 may be present in various states to inform the user that “the object is determined.”

The electronic device 100 according to an embodiment of the present disclosure may generate a captured image 515 including the object 550 in a virtual space. For example, the captured image 515 may be a captured image according to a preset capture mode and a preset capture area. For example, the preset capture mode may be, but is not limited to, a single-view capture mode for a first-person viewpoint from which the user currently views an object. For example, the preset capture mode may be a multi-view capture mode or 3D capture mode to be described below. For example, the preset capture area may be, but is not limited to, a range of a predefined virtual space around the object 550.

For example, the object 550 may be in a stationary or operational state. For example, when the object 550 is in a stationary state, the captured image 515 may include an object image in a stationary state. For example, when the object 550 is in an operational state, the captured image 515 may include an object image in a state in which a pointing gesture according to the first gesture 510 is released. For example, when the object 550 is in an operational state, the captured image 515 may include an object image of a state corresponding to the pointing gesture according to the first gesture 510 after a certain period of time elapses.

The electronic device 100 according to an embodiment of the present disclosure may display the captured image 515 in a partial area of the electronic device 100. For example, the electronic device 100 may display the captured image 515 in an upper right area of the electronic device 100.

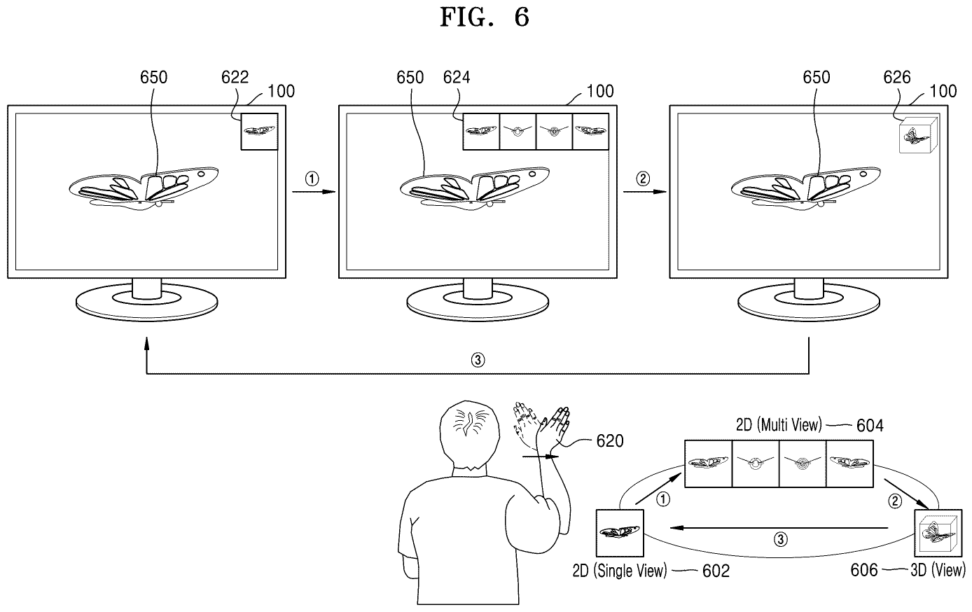

FIG. 6 is a diagram illustrating an operation of an electronic device, for determining a capture mode, according to an embodiment.

Referring to FIG. 6, the electronic device 100 according to an embodiment of the present disclosure may determine a capture mode, based on a second gesture 620 of a user. For example, the electronic device 100 may detect the second gesture 620 of swiping in one direction in space. The direction may be any one of upward, downward, left, and right directions. For example, the electronic device 100 may detect the second gesture 620 of swiping in a right direction and determine a capture mode.

For example, a capture mode 601 may include a single-view capture mode 602, a multi-view capture mode 604, and a 3D capture mode 606.

For example, a captured image 622 according to the single-view capture mode 602 may have a 2D image for a first-person viewpoint from which a user currently views an object. For example, when the user currently views a left side of an object 650 (e.g., a bird), the captured image 622 according to the single-view capture mode 602 may have a 2D image of the left side of the object 650.

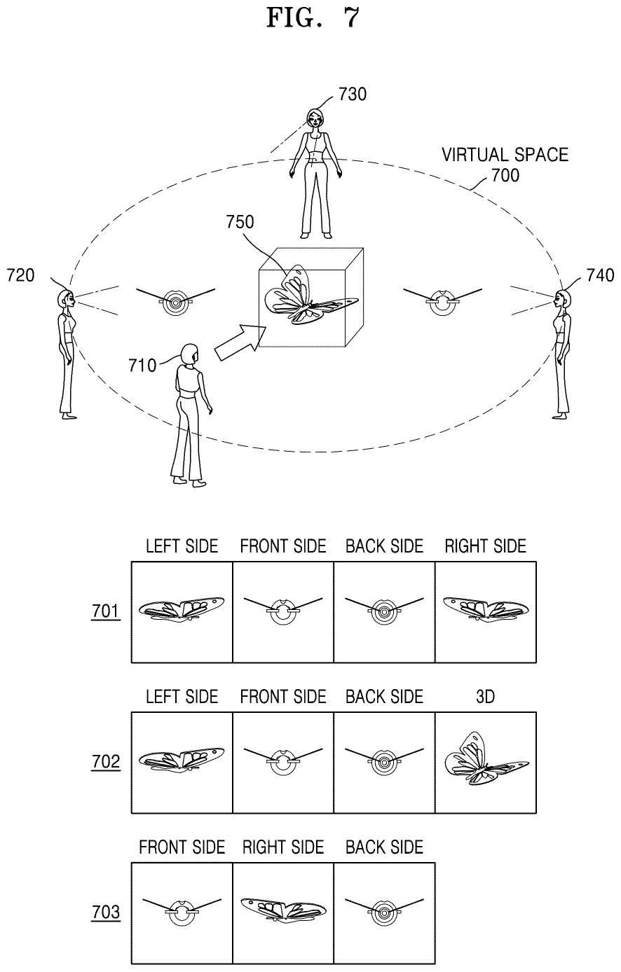

For example, a captured image 624 according to the multi-view capture mode 604 may have an image for multiple viewpoints obtained by rotation based on the object 650. For example, the captured image 624 according to the multi-view capture mode 604 may have images for four viewpoints obtained by rotating 90 degrees based on the object 650. For example, the captured image 624 may have 2D images of the left side, front side, back side, and right side of the object 650. In the present disclosure, the captured image 624 according to the multi-view capture mode 604 is described as having four viewpoints, but is not limited thereto. The number of captured images 624 according to the multi-view capture mode 604 may be less than four viewpoints or more than four viewpoints. The number of viewpoints of the captured image 624 according to the multi-view capture mode 604 may be preset or changed by user setting. The multi-view capture mode 604 is described in detail with reference to FIG. 7.

For example, a captured image 626 according to the 3D capture mode 606 may have a 3D image of the object 650. For example, the captured image 626 according to the 3D capture mode 606 may be an image containing various viewpoints experienced by the user.

The capture mode 601 according to an embodiment of the present disclosure may be changed to a next capture mode by a swiping gesture in one direction. For example, the capture mode 601 may be changed from the single-view capture mode 602 to the multi-view capture mode 604 (see \textcircled{1} in FIG. 6), may be changed from the multi-view capture mode 604 to the 3D capture mode 606 (see \textcircled{2} in FIG. 6), and may be changed from the 3D capture mode 606 to the single-view capture mode 602 (see \textcircled{3} in FIG. 6). Although not shown, the capture mode 601 may be changed to a previous capture mode by a swiping gesture in an opposite direction.

The electronic device 100 according to an embodiment of the present disclosure may generate a captured image according to a next capture mode, based on the second gesture 620 of moving in a right direction. For example, the electronic device 100 may generate the captured image 622 according to the single-view capture mode 602 as a capture service is initiated and the object 650 to be captured is determined. For example, the electronic device 100 may generate the captured image 624 according to the multi-view capture mode 604, based on the second gesture 620 of moving in the right direction (see \textcircled{1} in FIG. 6). For example, the electronic device 100 may generate the captured image 626 according to the 3D capture mode 606, based on the second gesture 620 of moving in the right direction (see \textcircled{2} in FIG. 6). For example, the electronic device 100 may generate the captured image 622 according to the single-view capture mode 602, based on the second gesture 620 of moving in the right direction (see \textcircled{3} in FIG. 6).

The electronic device 100 according to an embodiment of the present disclosure may generate a captured image according to a previous capture mode based on the second gesture 620 of moving in a left direction. For example, the electronic device 100 may change the capture mode from the single-view capture mode 602 to the 3D capture mode 606, from 3D capture mode 606 to the multi-view capture mode 604, or from the multi-view capture mode 604 to the single-view capture mode 602.

Based on determining that the second gesture 620 of selecting the capture mode is not present, the electronic device 100, according to an embodiment of the present disclosure, may determine the capture mode as a preset capture mode without changing the capture mode. For example, the electronic device 100 may determine the capture mode as a preset capture mode when the second gesture 620 is not detected for a certain period of time after the first gesture 510 is detected. For example, the electronic device 100 may generate a captured image according to a preset capture mode, that is, the captured image 622 according to the single-view capture mode 602.

FIG. 7 is a diagram showing a type of a multi-view capture mode from among capture modes according to an embodiment.

Referring to FIG. 7, the captured image 624 according to the multi-view capture mode 604 (see FIG. 6) is illustrated.

According to an embodiment of the present disclosure, a captured image according to the multi-view capture mode 604 may be any one of a first captured image 701, a second captured image 702, and a third captured image 703.

For example, the first captured image 701 may have images for multiple single-views obtained by rotation based on an object 750. For example, the first captured image 701 may have images for various viewpoints from which an avatar corresponding to a user views the object 750 within a virtual space 700, in addition to a current viewpoint 710 of the user. For example, the first captured image 701 may have images for four viewpoints obtained by rotating 90 degrees each based on the object 750. For example, the four viewpoints may include a first viewpoint 710 from which the object 750 is viewed from a left side, a first viewpoint 720 from which the object 750 is viewed from a back side, a second viewpoint 730 from which the object 750 is viewed from a right side, and a third viewpoint 740 from which the object 750 is viewed from a front side. For example, the first captured image 701 may have 2D images of the left side, the front side, the back side, and the right side. The first captured image 701 may correspond to the captured image 624 of FIG. 6.

In the present disclosure, the captured image 624 according to the multi-view capture mode 604 is described as having four viewpoints, but is not limited thereto. The number of captured images 624 according to the multi-view capture mode 604 may be less than four viewpoints or more than four viewpoints. The number of viewpoints of the captured image 624 according to the multi-view capture mode 604 may be preset or changed by user setting.

For example, the second captured image 702 may have images and 3D images for multiple single-views obtained by rotation based on the object 750. For example, the second captured image 702 may complexly have 2D images and 3D images for the left side, the front side, and the back side.

For example, the third captured image 703 may have an image that primarily represents a viewpoint from which the characteristics of the object 750 are represented. For example, in the case of a bird, the characteristics of the bird are usually most clearly represented when the bird is viewed from the front side. The electronic device 100 may determine priorities based on the characteristics of the object 750 and generate images for multiple viewpoints according to the priorities. For example, the third captured image 703 may have images of the front side, right side, and back side of the object 750 in order of priority. Alternatively, for example, when the object 750 is a building (not shown), a 3D image more clearly represents the characteristics of the building than a 2D image, and thus the third captured image 703 may have the 3D image and front image of the building. In this case, a first image of the third captured image 703 may be an image of a viewpoint that is not related to a current viewpoint of a user.

The electronic device 100 according to an embodiment of the present disclosure may capture an image of a virtual space viewed by the user not only as a simple 2D image but also as a multi-view image, a 3D image, and a complex image. The electronic device 100 according to an embodiment of the present disclosure may generate an image of a virtual space from a viewpoint from which the user does not view an object other than the current viewpoint of the user, and thus may amplify various viewpoints and emotions experienced by the user in the virtual space.

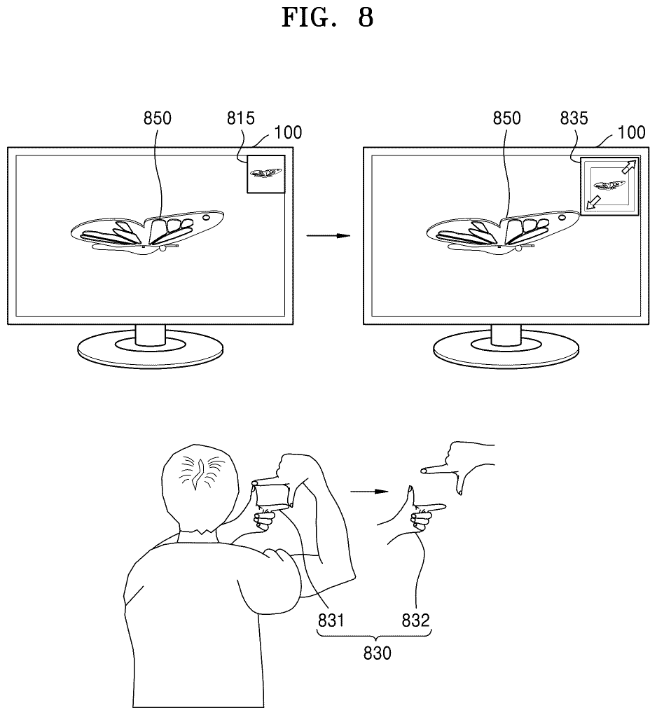

FIG. 8 is a diagram illustrating an operation of an electronic device, for determining a capture area, according to an embodiment.

Referring to FIG. 8, the electronic device 100 according to an embodiment of the present disclosure may determine a capture area, based on a third gesture 830 of a user. For example, the electronic device 100 may detect the third gesture 830 of zoom-in 832 or zoom-out 831 in space. When the electronic device 100 determines that the third gesture 830 of setting the capture area is present, it may change the capture area. For example, the electronic device 100 may extend or reduce a preset capture area according to the third gesture 830.

For example, the electronic device 100 may generate a captured image 835 with an extended capture area that includes object 850, based on the third gesture 830 of the zoom-in 832 in space. The captured image 835 may have a capture area with an extended range of a virtual space. The extended captured image 835 may be a 2D captured image.

In embodiments, upon determining that the third gesture 830 of setting a capture area is not present, the electronic device 100 may generate a captured image 815 according to a preset capture area without changing the capture area.

The electronic device 100 according to an embodiment of the present disclosure may amplify various viewpoints and emotions experienced by a user in a virtual space by arbitrarily extending or reducing the range of the virtual space viewed by the user and capturing the virtual space.

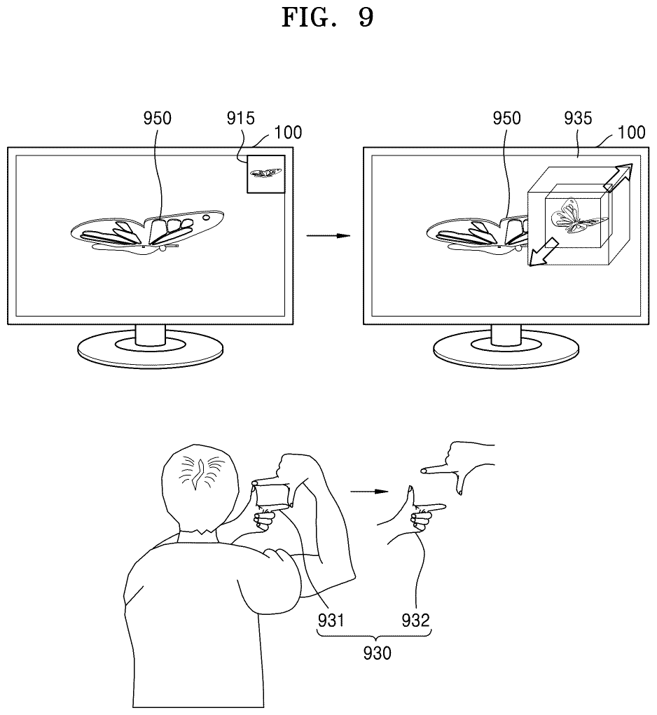

FIG. 9 is a diagram illustrating an operation of an electronic device, for determining a capture area, according to an embodiment.

Referring to FIG. 9, the electronic device 100 according to an embodiment of the present disclosure may generate a captured image with an extended or reduced capture area, based on a third gesture 930. For example, the electronic device 100 may extend a capture area and generate an extended captured image 935 by detecting the third gesture 930 of zoom-in 932 in space. The extended captured image 935 may be a 3D captured image and may include object 950.

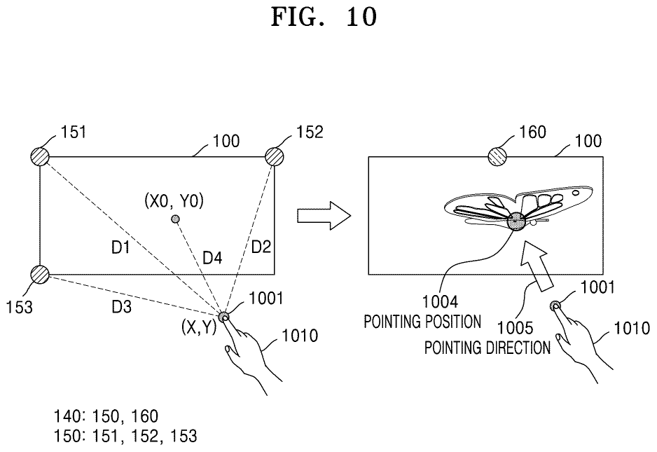

FIG. 10 is a diagram for explaining a method of detecting a first gesture through a sensor of an electronic device according to an embodiment.

The electronic device 100 according to an embodiment of the present disclosure may determine whether a first gesture 1010 of pointing to an object 1050 is present. The sensor 140 may detect the first gesture 1010 of pointing to the object 1050. The processor 110 may determine whether the first gesture 1010 is present through the sensor 140. The electronic device 100 according to an embodiment of the present disclosure may initiate a capture service, based on determining that the first gesture 1010 is present. The electronic device 100 according to an embodiment of the present disclosure may determine the object 1050 to be captured within a virtual space, based on determining that the first gesture 1010 is present.

The electronic device 100 according to an embodiment of the present disclosure may determine the position of a user hand 1001 and a distance between the user hand 1001 and the electronic device 100 through a distance sensor 150.

For example, the electronic device 100 according to an embodiment of the present disclosure may determine the position of the user hand 1001 through the distance sensor 150. The distance sensor 150 may detect the distance between the user hand 1001 and the distance sensor 150. The electronic device 100 according to an embodiment of the present disclosure may include a plurality of distance sensors 151, 152, and 153, and the plurality of distance sensors 151, 152, and 153 may include a first distance sensor 151, a second distance sensor 152, and a third distance sensor 153. For example, the first distance sensor 151 may detect a first distance D1 between the user hand 1001 and the first distance sensor 151. The second distance sensor 152 may detect a second distance D2 between the user hand 1001 and the second distance sensor 152. The third distance sensor 153 may detect a third distance D3 between the user hand 1001 and the third distance sensor 153.

For example, the electronic device 100 according to an embodiment of the present disclosure may determine the position of the user hand 1001 based on sensing data detected by the plurality of distance sensors 151, 152, and 153. For example, the processor 110 may determine a position (X, Y) of the user hand 1001 based on the first distance D1, the second distance D2, and the third distance D3. Here, the position of the user hand 1001 may be a position of a user fingertip pointing to the object 1050. For example, the electronic device 100 according to an embodiment of the present disclosure may detect the position of a feature point 1001, which is the position of the user fingertip. For example, the first gesture 1010 may have one feature point 1001.

For example, the electronic device 100 according to an embodiment of the present disclosure may determine a distance D4 between the electronic device 100 and the user hand 1001. For example, the electronic device 100 according to an embodiment of the present disclosure may determine the distance D4 between the electronic device 100 and the user hand 1001 based on a position (X0, Y0) of the electronic device 100 and the position (X, Y) of the user hand 1001 determined through the plurality of distance sensors 151, 152, and 153.

For example, the electronic device 100 according to an embodiment of the present disclosure may determine a pointing direction 1005 and a pointing position 1004 pointed by the user hand 1001 through an image sensor 160. The pointing direction 1005 refers to a direction pointed by the user hand 1001. The pointing position 1004 refers to a position pointed by the user hand 1001. The pointing position 1004 may be the same as, but is not limited to, the position of the object 1050 displayed on the electronic device 100.

For example, the image sensor 160 may track the user hand 1001. The electronic device 100 according to an embodiment of the present disclosure may determine the pointing direction 1005 and the pointing position 1004 pointed by the user hand 1001, based on the image tracked by the image sensor 160.

The electronic device 100 according to an embodiment of the present disclosure may determine the position of the object 1050 pointed by the user hand 1001, based on at least one of the position (X, Y), the pointing position 1004, and the pointing direction 1005 of the user hand 1001.

In FIG. 10, the plurality of distance sensors 151, 152, and 153 are illustrated as being located at three of the four corners of the electronic device 100, but are not limited thereto. The number of the plurality of distance sensors 151, 152, and 153 may be more than three or less than three. The plurality of distance sensors 151, 152, and 153 may be located anywhere inside the electronic device 100 other than at the corners of the electronic device 100. The image sensor 160 is illustrated as being located at an upper end of the electronic device 100, but is not limited thereto.

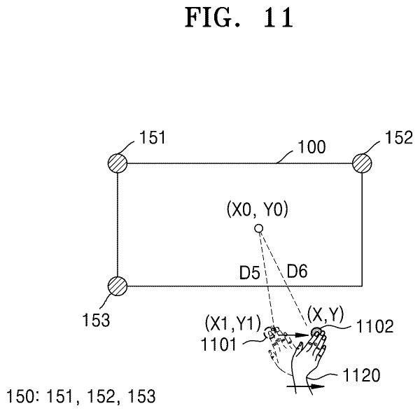

FIG. 11 is a diagram for explaining a method of detecting a second gesture through a sensor of an electronic device according to an embodiment.

The electronic device 100 according to an embodiment of the present disclosure may determine whether a second gesture 1120 is present, based on movement of user hands 1101 and 1102. The sensor 140 may detect presence or absence of movement and a movement direction of the user hands 1101 and 1102. The processor 110 may determine whether the second gesture 1120 is present through the sensor 140. The electronic device 100 according to an embodiment of the present disclosure may determine a capture mode, based on determining that the second gesture 1120 is present. The electronic device 100 according to an embodiment of the present disclosure may generate a captured image according to a selected capture mode. In contrast, the processor 110 according to an embodiment of the present disclosure may generate a captured image according to a preset capture mode, based on determining that the second gesture 1120 is not present.

The electronic device 100 according to an embodiment of the present disclosure may determine a change in the positions of the user hands 1101 and 1102 and a change in distances D5 and D6 between the user hands 1101 and 1102 and the electronic device 100 through the distance sensor 150.

For example, the second gesture 1120 may be a swiping gesture from left to right. The electronic device 100 according to an embodiment of the present disclosure may determine a first position (X1, Y1) and a second position (X2, Y2) of the user hands 1101 and 1102 through the distance sensor 150. The electronic device 100 according to an embodiment of the present disclosure may detect a swiping gesture through a change in the position of the user hands 1101 and 1102 moving from the first position (X1, Y1) to the second position (X2, Y2). In this case, the user hands 1101 and 1102 may have one feature point.

For example, the electronic device 100 according to an embodiment of the present disclosure may determine the fifth distance D5 and the sixth distance D6, which are distances between the electronic device 100 and the user hands 1101 and 1102. The electronic device 100 according to an embodiment of the present disclosure may detect a swiping gesture, based on a distance changed from the fifth distance D5 to the sixth distance D6.

For example, the electronic device 100 according to an embodiment of the present disclosure may determine a type of a gesture through a change in the position of the user hands 1101 and 1102, and thus may selectively deactivate the image sensor 160. Based on determining the second gesture 1120, the electronic device 100 according to an embodiment of the present disclosure may activate the distance sensor 150 and deactivate the image sensor 160. Accordingly, the electronic device 100 may operate at lower power than embodiments when the first gesture or the third gesture are determined.

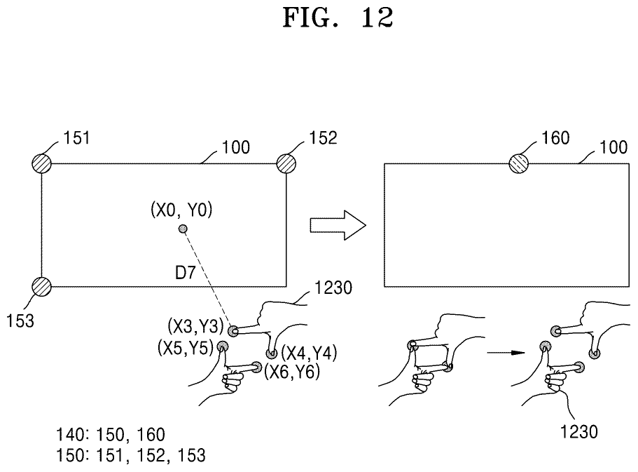

FIG. 12 is a diagram for explaining a method of detecting a third gesture through a sensor of an electronic device according to an embodiment.

The electronic device 100 according to an embodiment of the present disclosure may determine whether a third gesture 1230 is present based on user hands zooming in or out. The sensor 140 may detect gestures of the user hands and detect the position of the user hands. The processor may determine whether the third gesture 1230 is present through a sensor. The electronic device 100 according to an embodiment of the present disclosure may determine a range of a virtual space to be captured, based on the third gesture 1230. The electronic device 100 according to an embodiment of the present disclosure may generate a captured image in which a range of a virtual space to be captured is extended or reduced, based on determining that the third gesture 1230 is present. In contrast, the electronic device 100 according to an embodiment of the present disclosure may generate a captured image according to a preset capture area, based on determining that the third gesture 1230 is not present.

The electronic device 100 according to an embodiment of the present disclosure may determine a change in the position of a user hand and a change in a distance between the user hand and the electronic device 100 according to an embodiment of the present disclosure through the distance sensor 150.

For example, the third gesture 1230 may be a zoom-in or zoom-out gesture using two hands. The electronic device 100 according to an embodiment of the present disclosure may determine a third position (X3, Y3), a fourth position (X4, Y4), a fifth position (X5, Y5), and a sixth position (X6, Y6) of the user hand through the distance sensor 150. The electronic device 100 according to an embodiment of the present disclosure may detect a zoom-in or zoom-out gesture through a position change of the third position (X3, Y3), the fourth position (X4, Y4), the fifth position (X5, Y5), and the sixth position (X6, Y6). In this case, the user hand may have four feature points.

For example, the electronic device 100 according to an embodiment of the present disclosure may determine a distance between the electronic device 100 and the user hand. For example, the electronic device 100 according to an embodiment of the present disclosure may determine a seventh distance D7 between the third position (X3, Y3) of the user hand and the electronic device 100. Likewise, the electronic device 100 according to an embodiment of the present disclosure may determine a distance between each of the fourth position (X4, Y4), the fifth position (X5, Y5), and the sixth position (X6, Y6) and the electronic device 100 according to an embodiment of the present disclosure.

For example, the electronic device 100 according to an embodiment of the present disclosure may determine a gesture of the user hand through the image sensor 160. For example, the electronic device 100 according to an embodiment of the present disclosure may determine a zoom-in or zoom-out gesture by using two hands through the image sensor 160.

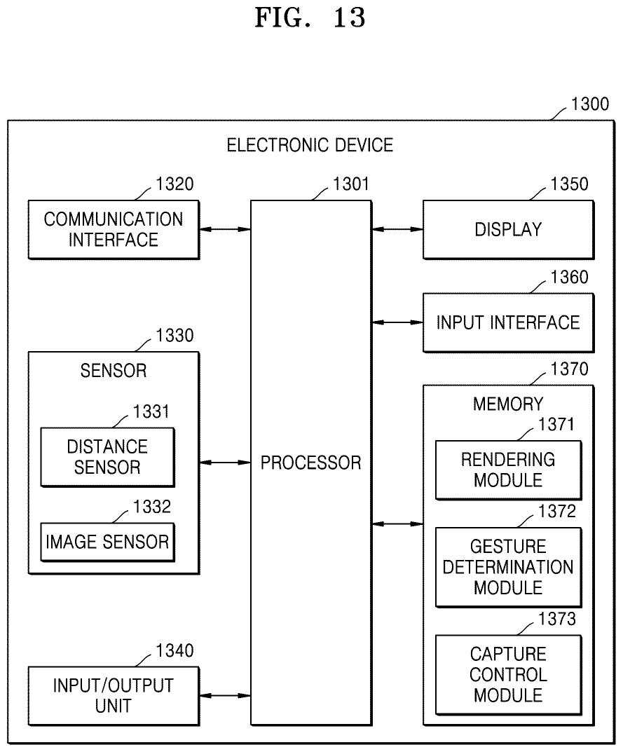

FIG. 13 is a detailed block diagram showing the configuration of an electronic device according to an embodiment.

An electronic device 1300 of FIG. 13 may be an example of the electronic device 100 of FIG. 2. Hereinafter, a repeated description of the description of FIG. 2 is omitted.

Referring to FIG. 13, the electronic device 1300 may include a processor 1301 and memory 1370. The processor 1301 and memory 1370 provided in the electronic device 1300 may perform the same operations as the processor 110 and memory 130 provided in the electronic device 100 of FIG. 2.

According to an embodiment, the electronic device 1300 may further include a communication interface 1320, a sensor 1330, an input/output unit 1340, a display 1350, and an input interface 1360 in addition to the processor 1301 and the memory 1370. The display 1350 may correspond to the display 120 of FIG. 2. The sensor 1330 may correspond to the sensor 140 of FIG. 2.

According to an embodiment, the communication interface 1320 may connect the electronic device 1300 to a peripheral device, an external device, a server, a mobile terminal, or the like under control of the processor 1301. The communication interface 1320 may include at least one communication module for performing wireless communication. The communication interface 1320 may include at least one of a wireless LAN module, a Bluetooth module, and a wired Ethernet module in accordance with the performance and structure of the electronic device 1300.

The sensor 1330 may detect a user image, a user interaction, a gesture, a touch, and the like and include a distance sensor 1331, an image sensor 1332, a gesture sensor, and a photoresistor. The distance sensor 1331 may include various sensors that detect a distance between the electronic device 100 and the user, such as an ultrasonic sensor, an infrared radiation (IR) sensor, and a time of flight (ToF) sensor. The distance sensor 1331 may detect a distance from the user and transmit sensing data to the processor 110. The image sensor 1332 may detect a user gesture through a camera or the like, and convert a received image into an electrical signal and transmit the electrical signal to the processor 110. The gesture sensor may detect movement speed or direction through an accelerometer or a gyro sensor. The photoresistor may detect ambient light.

The input/output unit 1340 may receive video (e.g., dynamic image signal or still image signal), audio (e.g., voice signal or music signal), and additional information from an external device under control of the processor 1301. The input/output unit 1340 may include one of a high-definition multimedia interface (HDMI) port, a component jack, a PC port, and a USB port.

The display 1350 may receive content from a broadcasting station, an external device such as an external server or external storage media, or output content provided by various applications, such as an over the top (OTT) service provider or a metaverse content provider, on a screen.

The input interface 1360 may receive or output user input for controlling the electronic device 1300. The input interface may include, but is not limited to, various types of user input devices, including a touch panel that detects a user touch, a button that receives a user push operation, a wheel that receives a user rotation operation, a keyboard, a dome switch, a microphone for voice recognition, and a motion detection sensor that senses motion.

According to an embodiment, the memory 1370 may store a rendering module 1371, a gesture determination module 1372, and a capture control module 1373.

The processor 1301 according to an embodiment may be configured to execute one or more instructions stored in each of the rendering module 1371, the gesture determination module 1372, and the capture control module 1373 to perform an operation according to the present disclosure.

The processor 1301 according to an embodiment may be configured to execute one or more instructions stored in the rendering module 1371 to render a virtual space based on data received from an external server or a metaverse content provider.

The processor 1301 according to an embodiment may be configured to execute one or more instructions stored in the gesture determination module 1372 to identify a hand gesture in space based on sensing data of the sensor 1330. For example, the processor 1301 may identify presence or absence of a hand gesture, a type of hand gesture, the position and direction of the hand gesture, and the like, based on sensing data of the sensor 1330.

The processor 1301 according to an embodiment may be configured to execute one or more instructions stored in the capture control module 1373 to perform an operation of a capture service according to the attribute of the identified hand gesture. For example, the processor 1301 may initiate the capture service, based on determining that a first gesture is present. For example, the processor 1301 may determine a capture mode, based on determining that a second gesture is present. For example, the processor 1301 may determine a capture area, based on determining that a third gesture is present.

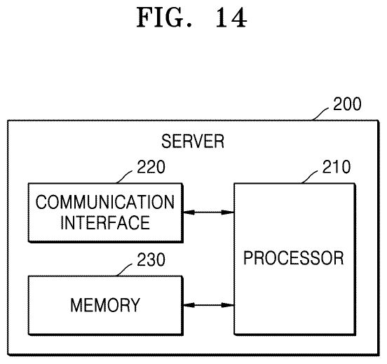

FIG. 14 is a block diagram showing the configuration of a server according to an embodiment.

Referring to FIG. 14, a server 200 is a device that generates virtual space content and provides the virtual space content such that users of various clients may access the virtual space content. The server 200 may generate and provide an avatar reflecting users of various clients. The server 200 may provide virtual space content to the electronic device 100, which is an example of a client, and may manage coordinates of an object (e.g., avatar) within the virtual space in response to input from a user of the electronic device 100. That is, the server 200 enables a user in real space and an object in virtual space to interact with each other.

The server 200 according to an embodiment may include a processor 210, a communication interface 220, and memory 230.

The communication interface 220 according to an embodiment may transmit and receive data or signals to and from the electronic device 100. For example, the communication interface 220 may include a Wi-Fi module, a Bluetooth module, an infrared communication module, a wireless communication module, a LAN module, an Ethernet module, and a wired communication module. In this case, each communication module may be implemented in the form of at least one hardware chip.

The communication interface 220 according to an embodiment may transmit a virtual space containing an avatar to the electronic device 100 under control of the processor 210.

The processor 210 according to an embodiment may control the overall operation of the server 200 and signal flow between internal components of the server 200, and perform a function of processing data.

The processor 210 according to an embodiment may include at least one of a central processing unit (CPU), a graphic processing unit (GPU), and a video processing unit (VPU). Alternatively, in some embodiments the processor 210 according to an embodiment may be implemented in the form of a system on chip (SoC) obtained by integrating at least one of a CPU, a GPU, and a VPU. Alternatively, the processor 210 may further include a neural processing unit (NPU).

The memory 230 according to an embodiment may store various data, programs or applications for driving and controlling the server 200. A program stored in the memory 230 may include one or more instructions. The program (one or more instructions) or application stored in the memory 230 may be executed by the processor 210. The memory 230 according to an embodiment may include one or more instructions for generating metaverse virtual space content. The memory 230 according to an embodiment may store virtual space content.

A device-readable storage medium may be provided in the form of a non-transitory storage medium. Here, the term ‘non-transitory storage medium’ simply means a tangible device that does not contain a signal (e.g. electromagnetic wave), and the term does not distinguish between cases in which data is stored semi-permanently or temporarily in a storage medium. For example, the ‘non-transitory storage medium’ may include a buffer in which data is temporarily stored.

According to an embodiment, methods according to various embodiments disclosed in the present disclosure may be provided as provided in a computer program product. The computer program product may be traded between a seller and a buyer as commodities. The computer program product may be distributed in the form of a machine-readable storage medium (e.g., compact disc read only memory (CD-ROM)), or may be distributed online (e.g., by download or upload) via an application store or directly between two user devices (e.g., smartphones). In the case of online distribution, at least some of computer program products (e.g., a downloadable application) may be temporarily stored or temporarily generated in a device-readable storage medium, such as memory of a server of a manufacturer, a server of an application store, or an intermediary server.

What is claimed is:

1. An electronic device comprising:
a display;
memory storing one or more instructions; and
at least one processor including processing circuitry,
wherein the one or more instructions are configured to, when executed by the at least one processor individually or collectively, cause the electronic device to:
control the display to display a virtual space,
based on a first gesture for capturing the virtual space, determine an object to be captured within the virtual space,
based on a second gesture for selecting a capture mode, determine the capture mode, and
generate a captured image of the object based on capturing the virtual space according to the capture mode.

2. The electronic device of claim 1, further comprising at least one sensor,
wherein the one or more instructions are further configured to, when executed by the at least one processor individually or collectively, cause the electronic device to, through the at least one sensor, identify the first gesture of pointing to the object.

3. The electronic device of claim 2, wherein the at least one sensor comprises a first sensor and a second sensor, and
wherein the one or more instructions are further configured to, when executed by the at least one processor individually or collectively, cause the electronic device to:
determine a position of a user hand through the first sensor,
determine a pointing direction pointed by the user hand through the second sensor, and
based on the position of the user hand and the pointing direction, determine a position of the object within the virtual space, pointed by the user hand.

4. The electronic device of claim 1, wherein the one or more instructions are further configured to, when executed by the at least one processor individually or collectively, cause the electronic device to control the display to display a highlight icon indicating that the object to be captured is determined, based on the first gesture.

5. The electronic device of claim 1, wherein the capture mode comprises:
a single-view capture mode in which the captured image for a current viewpoint is generated; and
a multi-view capture mode in which the captured image for multiple viewpoints obtained by rotation based on the object is generated.

6. The electronic device of claim 5, wherein the capture mode further comprises a three-dimensional (3D) capture mode in which a 3D captured image for the object is generated.

7. The electronic device of claim 1, wherein the one or more instructions are further configured to, when executed by the at least one processor individually or collectively, cause the electronic device to:
based on determining that the second gesture is present, generate the captured image based on the capture mode, and
based on determining that the second gesture is not present, generate the captured image according to a preset capture mode.

8. The electronic device of claim 1, further comprising at least one sensor,
wherein the one or more instructions are further configured to, when executed by the at least one processor individually or collectively, cause the electronic device to, based on movement of a user hand, detect, through the at least one sensor, the second gesture.

9. The electronic device of claim 8, wherein the one or more instructions are further configured to, when executed by the at least one processor individually or collectively, cause the electronic device to, based on the user hand moving in a first direction, generate the captured image according to a next capture mode, and
based on the user hand moving in a second direction opposite to the first direction, generate the captured image according to a previous capture mode.

10. The electronic device of claim 1, wherein the one or more instructions are further configured to, when executed by the at least one processor individually or collectively, cause the electronic device to, based on a third gesture for setting a capture area, determine a range of a virtual space to be captured.

11. The electronic device of claim 10, wherein the one or more instructions are further configured to, when executed by the at least one processor individually or collectively, cause the electronic device to:
based on determining that the third gesture is present, generate the captured image in which the range of the virtual space to be captured is extended or reduced, and
based on determining that the third gesture is not present, generate the captured image according to a preset capture area.

12. The electronic device of claim 10, further comprising at least one sensor,
wherein the one or more instructions are further configured to, when executed by the at least one processor individually or collectively, cause the electronic device to, based on detecting that user hands zoom in or zoom out through the at least one sensor, determine whether the third gesture is present.

13. An operation method of an electronic device, the operation method performed by at least one processor individually or collectively, the operation method comprising:
controlling a display of the electronic device to display a virtual space;
based on a first gesture for capturing the virtual space, determining an object to be captured within the virtual space;
based on a second gesture for selecting a capture mode, determining the capture mode; and
generating a captured image of the object based on capturing the virtual space according to the capture mode.

14. The operation method of claim 13, wherein, based on the first gesture for capturing the virtual space, the determining of the object to be captured within the virtual space comprises identifying, through at least one sensor, the first gesture of pointing to the object.

15. The operation method of claim 13, wherein the capture mode further comprises at least one of:
a single-view capture mode in which the captured image for a current viewpoint is generated;
a multi-view capture mode in which the captured image for multiple viewpoints obtained by rotation based on the object is generated; and
a three-dimensional (3D) capture mode in which a 3D captured image for the object is generated.
